(19) United States
(12) Patent Application Publication
(10) Pub. No.: US 2026/0279691 A1
(43) Pub. Date: Sep. 17, 2026

(54) DIELECTRIC, CAPACITOR INCLUDING SAME, AND DEVICE COMPRISING CAPACITOR

(71) Applicant: Panasonic Intellectual Property Management Co., Ltd., Osaka (JP)

(72) Inventors: TAKAHIRO YOSHINO, Osaka (JP); YUKI IDE, Kyoto (JP); HIROAKI SUZUKI, Osaka (JP); HITOSHI ISHIMOTO, Hyogo (JP); MASAHIRO UEDA, Osaka (JP)

(21) Appl. No.: 19/138,182

(22) PCT Filed: Dec. 11, 2023
(86) PCT No.: PCT/JP2023/044145

§ 371 Date: Jun. 12, 2025

(30) Foreign Application Priority Data
Dec. 28, 2022 (JP) 2022-211861

(51) Int. Cl. H01G 9/07; H01G 9/04; H01G 9/15

(52) U.S. Cl. CPC H01G 9/07; H01G 9/04; H01G 9/15

(57) ABSTRACT

A dielectric contains a tantalum compound. The tantalum compound contains oxygen, and a first element other than oxygen and tantalum. The first element contains an atom having a valance electron number of four or less, and is capable of being a tetravalent positive ion in an ionic state.

### TECHNICAL FIELD

The present disclosure relates to a dielectric, a capacitor including the dielectric, and a device including the capacitor.

### BACKGROUND ART

A capacitor element includes a first electrode, a second electrode, and a dielectric interposed between these electrodes, for example. As an anode body included in an anode as the first electrode, metal foil or a porous body containing a valve action metal is used, for example. Examples of the valve action metal include tantalum, niobium, and aluminum. The dielectric is formed covering at least a part of a surface of the anode body by a gas phase method (sputtering, atomic layer deposition, etc.) or chemical conversion treatment, for example.

PTL 1 proposes a dielectric containing an amorphous tantalum compound containing fluorine and oxygen. The dielectric in PTL 1 is formed by RF magnetron sputtering or anodizing using an aqueous solution containing NaF and NaOH.

PTL 2 proposes electrode foil for a capacitor, the electrode foil including: an anode body including a porous part and containing a first metal; a first dielectric layer covering at least a part of the porous part; and a second dielectric layer covering at least a part of the first dielectric layer and containing an oxide of a second metal, the first dielectric layer including a first part having thickness T₁ and a second part having thickness T₂ smaller than thickness T₁. PTL 2 shows the first dielectric layer that is a natural oxide film, and the second dielectric layer that is formed by atomic layer deposition.

When the dielectric of the capacitor element is formed by anodizing, an aqueous phosphoric acid solution is used in many cases (PTL 3, etc.).

### CITATION LIST

### Patent Literature

PTL 1: Japanese Patent No. 7122617

PTL 2: International Publication No. WO 2021/192607

PTL 3: Unexamined Japanese Patent Publication No. 2011-77257

### SUMMARY OF THE INVENTION

A first aspect of the present disclosure relates to a dielectric containing a tantalum compound, in which the tantalum compound contains oxygen, and a first element other than oxygen and tantalum, and the first element is an element having a valance electron number of four or less, and is capable of being a positive ion in an ionic state.

A second aspect of the present disclosure relates to a capacitor including a first electrode, a second electrode, and the dielectric disposed between the first electrode and the second electrode.

A third aspect of the present disclosure relates to a device including the capacitor.

The present disclosure can provide the dielectric capable of obtaining high capacitance and high withstand voltage in the capacitor.

### BRIEF DESCRIPTION OF THE DRAWINGS

FIG. 1 is a sectional view schematically illustrating a capacitor element including a dielectric according to an exemplary embodiment of the present disclosure.

FIG. 2 is a sectional view schematically illustrating a capacitor according to an exemplary embodiment of the present disclosure.

FIG. 3 shows an analysis result of a negative mode by time-of-flight secondary ion mass spectrometry of an outermost surface of an oxide film (dielectric) of Example 1 and the inside thereof.

FIG. 4 shows an analysis result of a positive mode by the time-of-flight secondary ion mass spectrometry of the outermost surface of the oxide film (dielectric) of Example 1 and the inside thereof.

FIG. 5 shows an analysis result of the negative mode by the time-of-flight secondary ion mass spectrometry of an outermost surface of an oxide film (dielectric) of Comparative Example 1 and the inside thereof.

FIG. 6 shows an analysis result of the positive mode by the time-of-flight secondary ion mass spectrometry of the outermost surface of the oxide film (dielectric) of Comparative Example 1 and the inside thereof.

FIG. 7 shows elemental analysis spectra of the outermost surface of the oxide film (dielectric) of each of Example 1 and Comparative Example 1 by X-ray photoelectron spectroscopy.

FIG. 8 shows elemental analysis spectra of the outermost surface of the oxide film (dielectric) of each of Example 1 and Comparative Example 1 by the X-ray photoelectron spectroscopy.

### DESCRIPTION OF EMBODIMENT

A capacitor has a trade-off relationship between high capacitance and high withstand voltage (withstand voltage), which are less likely to be achieved together. For example, as the dielectric decreases in thickness or increases in dielectric constant, a higher capacitance is obtained, but withstand voltage decreases.

In general, a capacitor using an electrode containing tantalum uses a porous body for an electrode such as an anode from the viewpoint of increasing a surface area of the electrode to secure high capacitance. Examples of the porous body include a porous molded body obtained by molding particles containing tantalum, and a porous sintered body obtained by sintering the porous molded body. From the viewpoint of securing high capacitance, a dielectric formed thinly covering an unevenness surface of the porous body has an advantage, and thus chemical conversion treatment using a chemical conversion solution is used in many cases. Although a dielectric may be formed by a gas phase method such as sputtering, the gas phase method is less likely to uniformly deposit components constituting the dielectric on a surface of the porous body without unevenness than a liquid phase method, and requires a vacuum inside a chamber. Thus, cost tends to increase. Thus, the gas phase method is disadvantageous in industrial mass production by forming a film of a dielectric having high capacitance and high withstand voltage.

In general, an aqueous phosphoric acid solution is used as the chemical conversion solution in many cases. Unfortunately, the chemical conversion treatment using the phosphoric acid aqueous solution is less likely to obtain high withstand voltage due to phosphorus element mixed into the dielectric to be formed, the phosphorus element causing a leakage current. Additionally, an oxide of the electrode containing tantalum, the oxide being formed by the chemical conversion treatment, has a dielectric constant higher than a dielectric constant of aluminum oxide or the like, so that high capacitance is likely to be obtained, however, the withstand voltage is low.

In view of the above, the dielectric of the present disclosure includes a tantalum compound (Technique 1). The tantalum compound contains oxygen, and a first element other than oxygen and tantalum. The first element is an element having a valence electron number of four or less, and is capable of being a positive ion in an ionic state.

When the dielectric of the present disclosure is used in a capacitor, high capacitance and high withstand voltage can be secured. This is because of consideration as follows. When the tantalum compound constituting the dielectric contains the first element, charge is compensated, and a defect level of oxygen is stabilized. Consequently, a leakage current is less likely to flow, thereby improving withstand voltage. When the dielectric contains tantalum and oxygen, high capacitance is obtained. Additionally, when the dielectric contains the first element, high withstand voltage is secured without increasing a thickness of the dielectric. Thus, high capacitance is less likely to be impaired.

The first element is an element containing an atom having a valance electron number of four or less, and is capable of being a positive ion. However, the first element does not include a carbon element. The first element is not necessarily in a positive ion state of the first element in the dielectric. The first element may be bonded to another element such as oxygen in the dielectric.

(Technique 2) In (Technique 1) described above, the first element may be unevenly distributed on a surface layer of the dielectric. When the first element is unevenly distributed on the surface layer, the first element unevenly distributed enables reducing leakage current and securing high withstand voltage while securing high capacitance by suppressing decrease in the dielectric constant of the entire dielectric.

When an average thickness of the dielectric is designated by T, the surface layer of the dielectric is a part from the outermost surface of the dielectric to a thickness of 0.3T from the outermost surface, i.e., the part from an outermost surface to a part at depth 0.3T. The surface layer of the dielectric is opposite to an anode body of the dielectric in the capacitor, for example.

The distribution of the first element in the dielectric is obtained by X-ray photoelectron spectroscopy (XPS). More specifically, when XPS analysis is performed on the dielectric while sputtering is performed on the dielectric from above its surface, a content (atom %) of the dielectric in the surface of the dielectric and in a depth direction (i.e., a thickness direction) from the surface is acquired. The XPS analysis is performed under the following conditions.

X-ray photoelectron spectrometer: VersaProbe (manufactured by ULVAC, Inc.)
X-ray source: monochromated-Al-Kα
Measurement diameter: a diameter of 100 μm
Photoelectron extraction angle: 90°
Use of neutralization mechanism
Etching conditions:
   Sputtering ion species: Ar⁺
   Acceleration voltage: 2 kV
   Raster area: about 2 mm×2 mm
   SiO₂ sputtering rate under the above conditions: 5.4 nm/min.

As a sample for the XPS analysis, a first electrode (more specifically, an anode) on which a dielectric is formed is used, for example. In this case, tantalum foil having a side with a length from 10 mm to 50 mm inclusive is used as the first electrode. Hereinafter, the sample is referred to as sample A. A first electrode (specifically, an anode) on which a dielectric layer obtained in a process of producing a capacitor or a capacitor element is formed may be used as a sample. Hereinafter, the sample is referred to as sample B.

A thickness of the dielectric is acquired from an image obtained by a scanning electron microscope (SEM). Average thickness T of the dielectric is acquired by measuring and averaging thicknesses of the dielectric at a plurality of arbitrary positions (e.g., ten locations). More specifically, a section parallel to the thickness direction is first exposed for sample A or sample B, and an image of the section obtained by SEM is photographed. Thicknesses of the dielectric are acquired at a plurality of arbitrary positions in visual fields at a plurality of arbitrary positions in this image. A sample for photographing the image of the section is obtained by the following procedure. First, sample A or sample B is embedded in a curable resin to cure the curable resin. A cured product is subjected to wet polishing or dry polishing to expose a section parallel to a thickness direction of the dielectric (a section in which layer structure of the dielectric can be checked). The exposed section is smoothed by ion milling to obtain a sample for photographing.

(Technique 3) In (Technique 1) or (Technique 2) described above, a content of the first element may range from 10 atom % to 30 atom % inclusive, in a portion from the outermost surface of the surface layer of the dielectric to a position away from the outermost surface by thickness of 10 nm. The dielectric includes the portion from the outermost surface of the surface layer to the thickness of 10 nm from the outermost surface (i.e., the part from the outermost surface to a depth of 10 nm) that may be simply referred to as an “outermost layer part”. When the content of the first element is 10 atom % or more in the outermost layer part, higher withstand voltage can be secured while decrease in capacitance is suppressed. When the content of the first element is 30 atom % or less in the outermost layer part, higher capacitance is likely to be secured. The content of the first element in the outermost layer part is an average value of contents of the first element acquired in the part from the outermost surface of the surface layer to the thickness of 10 nm from the outermost surface, the first element contents being acquired by the XPS analysis described above. A content of phosphorus is about 3 atom % in the outermost layer of a dielectric formed by general chemical conversion treatment using a phosphoric acid aqueous solution.

(Technique 4) In any one of (Technique 1) to (Technique 3), the content of the first element may range from 10 atom % to 30 atom % inclusive, at the outermost surface of the surface layer of the dielectric. In this case, higher capacitance and higher withstand voltage can be secured. The content of the first element in the outermost surface is an average value of contents of the first element acquired for a plurality of places (e.g., ten places) of the outermost surface of the dielectric, the first element contents being acquired by the XPS analysis described above.

The outermost layer part of the surface layer is the outermost layer part of the dielectric layer. Similarly, the outermost surface of the surface layer is the outermost surface of the dielectric. The outermost layer part and the outermost surface of the dielectric are each opposite to the anode body of the dielectric in the capacitor, for example.

The dielectric of the present disclosure includes the surface layer in which the first element is unevenly distributed. This kind of dielectric has a spectrum obtained by the XPS performed on the outermost surface of the surface layer of the dielectric, in which a peak attributed to the first element is observed, for example. In this case, a leak current can be reduced and high withstand voltage can be secured while high capacitance is secured. Any one of (Technique 1) to (Technique 4) may further have a feature as described above.

(Technique 5) For any one of the (Technique 1) to (Technique 4) above, in a spectrum obtained by an X-ray photoelectron spectroscopy at the outermost surface of the surface layer of the dielectric, a peak attributed to O₁ₛ derived from a bond between the first element and oxygen may be observed. In this case, not only high capacitance but also higher withstand voltage can be secured.

(Technique 6) In any one of (Technique 1) to (Technique 5), the first element preferably includes an element in which a dielectric constant of an oxide is lower than a dielectric constant of an oxide of tantalum. When the first element contains this kind of element, higher withstand voltage can be secured. When the surface layer contains the first element in an unevenly distributed state, decrease in the dielectric constant of the entire dielectric is suppressed. Thus, higher capacitance is obtained, and the surface layer can secure higher withstand voltage.

(Technique 7) In any one of (Technique 1) to (Technique 6), the first element may include at least one selected from the group consisting of Group 4 elements and Group 14 elements of the periodic table. The periodic table is a long-form periodic table. When the dielectric contains this kind of first element, a charge is likely to be compensated, and a defect level of oxygen is likely to be more stabilized.

(Technique 8) In any one of (Technique 1) to (Technique 7), the first element preferably contains at least a silicon element. In this case, a charge is likely to be compensated and the defect level of oxygen is likely to be more stabilized in the dielectric. Additionally, a silicon oxide has a dielectric constant lower than a dielectric constant of a tantalum oxide, so that withstand voltage of a part of the dielectric, the part containing the silicon element, is likely to improve.

(Technique 9) In (Technique 8) above, in a spectrum obtained by an X-ray photoelectron spectroscopy at an outermost surface of the surface layer, a peak attributed to Si₂ₚ may be observed in the spectrum In this case, higher withstand voltage is likely to be obtained while high capacitance is secured.

(Technique 10) In any one of (Technique 1) to (Technique 9), a withstand voltage of the surface layer preferably is higher than a withstand voltage of a part of the dielectric, the part excluding the surface layer. In this case, the surface layer can secure high withstand voltage while high capacitance is maintained.

The present disclosure also includes a capacitor including the dielectric described above. (Technique 11) A capacitor includes a first electrode, a second electrode, and the dielectric according to any one of (Technique 1) to (Technique 10), the dielectric being disposed between the first electrode and the second electrode. This kind of capacitor can achieve both high capacitance and high withstand voltage.

(Technique 12) In (Technique 11) above, the first electrode may contain tantalum, and the dielectric may be an oxide film of the first electrode. The first element may be unevenly distributed in a surface layer of the dielectric, the surface layer being located close to the second electrode. When the dielectric is the oxide film of the first electrode, the first element is likely to be unevenly distributed in the surface layer of the dielectric on the side close to the second electrode. Thus, the surface layer can secure higher withstand voltage while higher capacitance is maintained.

(Technique 13) In (Technique 11) or (Technique 12) above, the capacitor may include an electrolyte interposed between the first electrode and the second electrode. In this case, higher capacitance can be obtained.

(Technique 14) The present disclosure also includes a device including the capacitor according to any one of (Technique 11) to (Technique 13).

Hereinafter, the dielectric, the capacitor, and the device of the present disclosure, including (Technique 1) to (Technique 14) above, will be described in more detail. At least one component selected from components described below can be appropriately combined with at least one of (Technique 1) to (Technique 14) above of the present disclosure as long as the one component can be technically combined.

### Dielectric

The dielectric contains a tantalum compound that contains oxygen and the first element. The first element can also be said as a doped element doped in the tantalum compound constituting the dielectric. When the dielectric contains the first element, charge is compensated, and a defect level of oxygen is stabilized, whereby a leak current is suppressed. As a result, high withstand voltage can be secured by the first element while high capacitance is secured by the tantalum compound.

The first element may be contained in the dielectric layer in a state of being bonded to oxygen, or may be contained as a monatomic ion. When the dielectric is analyzed by time-of-flight secondary ion mass spectrometry (TOF-SIMS), the first element is detected in the form of an oxide in many cases. An oxidation number of the first element in the oxide is not particularly limited. For example, when the first element contains a silicon element, the silicon element is detected as SiO₂, SiO₃, SiO₃H, Si₂O₅H, Si ions, or the like in the TOF-SIMS. The analysis may use any one of a negative mode and a positive mode depending on chemical species to be analyzed. Analysis by the TOF-SIMS is performed while the dielectric is etched in the depth direction (e.g., from the outermost surface of the dielectric toward the first electrode) from the outermost surface.

The surface layer of the dielectric preferably has a withstand voltage higher than that of a part of the dielectric, the part excluding the surface layer. The part of the dielectric, the part excluding the surface layer, can obtain high capacitance, and the surface layer of the dielectric can secure high withstand voltage.

The first element is preferably unevenly distributed in the surface layer of the dielectric. That is, the content of the first element in the surface layer of the dielectric is higher than that in the part of the dielectric, the part excluding the surface layer. The first element is unevenly distributed in the surface layer, so that high withstand voltage can be secured in the surface layer, and decrease in capacitance can be suppressed. In this case, it can be said that the surface layer has a withstand voltage higher than that of the part of the dielectric, the part excluding the surface layer.

The surface layer of the dielectric is one of a pair of surfaces located at respective ends in the thickness direction of the dielectric. When the dielectric is formed covering the first electrode, the surface layer of the dielectric corresponds to a surface layer on a side opposite to the first electrode of the dielectric (i.e., a side close to the second electrode).

A content of the first element at a position with a thickness of 0.06T from the outermost surface of the dielectric is defined as r1, and a content of the first element at a position with a thickness of 0.50T from the outermost surface is defined as r2. At this time, a ratio of r1 to r2 (=r1/r2) may be from 10 to 10,000 inclusive, from 50 to 1000 inclusive, from 100 to 1000 inclusive, or from 50 to 500 inclusive. Ratio r1/r2 represents a degree of uneven distribution of the first element, and a larger value of the ratio means a larger degree of uneven distribution. When ratio r1/r2 is in the above range, it is advantageous in that higher withstand voltage can be obtained while decrease in capacitance caused by the entire dielectric is suppressed.

From the viewpoint of easily obtaining higher withstand voltage while securing higher capacitance, the outermost layer of the dielectric preferably contains a large amount of the first element. For example, the content of the first element may be 10 atom % or more, or 15 atom % or more in the portion from the outermost surface of the surface layer of the dielectric to a position away from the outermost surface (i.e., the outermost layer). From the viewpoint of easily securing higher capacitance, the content of the first element may be 30 atom % or less, or 25 atom % or less in the outermost layer of the dielectric. These lower limit value and upper limit value can be appropriately combined.

The outermost layer of the dielectric contains many first elements, so that a content of a tantalum element in the outermost layer tends to be lower than that in a conventional dielectric containing a tantalum compound. The content of tantalum element may be from 3 atom % to 15 atom % inclusive, or from 5 atom % to 15 atom % inclusive in the outermost layer of the dielectric. The content of tantalum element is about 18 atom % in the outermost layer in a general dielectric formed by chemical conversion on an anode body using a phosphoric acid aqueous solution. The content of tantalum element is acquired by the XPS analysis as for the first element.

From the viewpoint of easily obtaining higher withstand voltage while securing higher capacitance, a content of the first element may range from 10 atom % to 30 atom % inclusive, or from 15 atom % to 25 atom % inclusive in the outermost surface of the dielectric.

The first element may contain an element in which an oxide has a dielectric constant lower than that of an oxide of tantalum. In this case, an effect of improving withstand voltage is enhanced. When a large amount of this kind of element is contained in the surface layer or the outermost layer of the dielectric, not only decrease in the dielectric constant of the entire dielectric can be suppressed to secure higher capacitance, but also withstand voltage can be further improved by decrease in the dielectric constant of the surface layer or the outermost layer in addition to stabilization of a defect level of oxygen.

The first element may include at least one selected from the group consisting of Group 1 elements and Group 14 elements of the periodic table. In particular, the first element preferably contains at least one kind of element selected from the group consisting of Group 4 elements and Group 14 elements of the periodic table. Group 4 elements include titanium, zirconium, hafnium, and razafordium. Group 14 elements include carbon, silicon, germanium, tin, lead, and the like. Although carbon may be selected from Group 14 elements, an element other than carbon is preferably selected from the viewpoint of easily stabilizing a defect level of oxygen. The first element preferably contains also at least one kind of element selected from a group consisting of silicon, germanium, and hafnium. The first element may be selected from Group 14 elements by a thickness of 10 nm. In particular, the first element preferably contains at least a silicon element. When the first element contains this kind of element, an effect of stabilizing the defect level of oxygen is higher than that when the first element contains carbon, for example. Thus, a leak current is suppressed, and higher withstand voltage can be secured. A silicon oxide has a dielectric constant lower than that a tantalum oxide, so that an effect of improving withstand voltage is enhanced when the dielectric contains silicon.

The outermost surface (or outermost layer) of the surface layer of the dielectric contains many first elements. Thus, a peak attributed to the first element is observed in an XPS spectrum of the outermost surface of the surface layer. The XPS spectrum of the outermost surface of the surface layer may be observed to observe a peak attributed to O1s derived from a bond between the first element and oxygen.

For example, when the dielectric contains silicon, a peak attributed to Si₂ₚ may be observed in the XPS spectrum of the outermost surface of the surface layer of the dielectric. The peak attributed to Si₂ₚ is observed in a bond energy range from 99 eV to 105 eV inclusive (particularly, from 102 eV to 104 eV inclusive) in the XPS spectrum, for example. The dielectric exhibiting this kind of peak contains ion species containing silicon at least in the outermost surface, and can secure higher withstand voltage. For the conventional dielectric formed using a phosphoric acid aqueous solution, this kind of peak is not observed.

When the dielectric contains silicon, a peak attributed to Ols derived from a Si—O bond may be observed in the XPS spectrum of the outermost surface of the surface layer of the dielectric. This kind of peak is observed in a bond energy range from 528 eV to 534 eV inclusive (particularly, from 532 eV to 534 eV inclusive) in the XPS spectrum, for example. The dielectric exhibiting this kind of peak contains silicon oxide at least in the outermost surface, and can secure higher withstand voltage. For the conventional dielectric formed using a phosphoric acid aqueous solution, this kind of peak is not observed.

For the conventional dielectric formed using a phosphoric acid aqueous solution, a peak attributed to P₂ₚ derived from a phosphorus-containing ion species is observed in an XPS spectrum of the outermost surface of a surface layer of a dielectric. In contrast, no peak attributed to P₂ₚ is observed in the XPS spectrum of the outermost surface of the surface layer of the dielectric of the present disclosure. This kind of peak is observed in a bond energy range from 130 eV to 135 eV inclusive in the XPS spectrum, for example.

The XPS analysis can be performed using sample A or sample B described above under similar conditions as for the analysis of the first element.

The dielectric may contain oxygen, tantalum, and an element other than the first element (referred to as a second element) as necessary. The dielectric may contain one kind of the second element, or two or more kinds thereof. A content of each second element is usually lower than a content of tantalum or a content of the first element. For example, the content of each second element in the outermost layer of the dielectric is lower than the content of tantalum. The content of each second element may be 5 atom % or less, or 3 atom % or less in the outermost layer of the dielectric.

Average thickness T of the dielectric may be from 100 nm to 300 nm inclusive, or from 130 nm to 250 nm inclusive. When thickness T is in such a range, higher capacitance is obtained. Even when thickness T is as relatively small as 200 nm or less (e.g., from 100 nm to 200 nm inclusive, or from 130 nm to 200 nm inclusive), or 175 nm or less (e.g., from 100 nm to 175 nm inclusive, or 130 nm to 175 nm inclusive), high withstand voltage can be secured by the first element, and thus both high capacitance and withstand voltage can be achieved.

The dielectric may be formed by a gas phase method. The dielectric is preferably formed by oxidation of the first electrode using a liquid mixture containing the first element. That is, the dielectric is preferably an oxide film of the first electrode. This kind of dielectric is formed by oxidizing a surface of the first electrode while the liquid mixture is in contact with at least a part of the surface of the first electrode (e.g., an anode (more specifically, an anode body)) containing tantalum, for example. When the dielectric is formed by oxidation of the surface of the first electrode, a thin oxide film is likely to be formed covering an uneven surface of the dielectric as compared with when the dielectric is formed by the gas phase method. Additionally, the first element is likely to be unevenly distributed in the surface layer or the outermost layer of the dielectric. Thus, the gas phase method is advantageous in obtaining higher capacitance and securing higher withstand voltage.

The liquid mixture used for oxidation of the first electrode (more specifically, the anode body) is an aqueous solution containing the first element, for example. The first element may be contained in any form in the liquid mixture. For example, the first element may be contained in the liquid mixture in the form of a monoatomic ion or a polyatomic ion.

The concentration of the first element in the liquid mixture may be from 0.01 mass % to 5.00 mass % inclusive, from 0.05 mass % to 0.70 mass % inclusive, or from 0.08 mass % to 0.50 mass % inclusive. When the concentration of the first element is in such a range, the dielectric is likely to be doped with the first element, and thus higher withstand voltage is likely to be obtained. Additionally, the first element is likely to be unevenly distributed in the surface layer or the outermost layer.

The oxidation of the first electrode may be performed while voltage is applied to the first electrode. Voltage (referred to also as oxidation voltage) applied to the first electrode may be from 30 V to 100 V inclusive, or from 50 V to 100 V inclusive. The oxidation of the first electrode may be performed under a predetermined voltage or a voltage increasing at a predetermined speed, or a combination of the voltages. The oxidation voltage is voltage of the first electrode with respect to a counter electrode.

The oxidation of the first electrode may be performed at room temperature or under heating. Temperature of the liquid mixture during the oxidation may be from 20° C. to 80° C. inclusive, from 40° C. to 80° C. inclusive, or from 50° C. to 75° C. inclusive.

### Capacitor

The capacitor of the present disclosure includes the dielectric. The capacitor includes the dielectric disposed between the first electrode and the second electrode. The dielectric is preferably formed covering at least a part of the surface of the first electrode (more specifically, the anode). This kind of dielectric may form a layer (referred to also as a dielectric layer). The capacitor may include an electrolyte.

The capacitor may include a capacitor element and an exterior body that seals the capacitor element. The capacitor element includes a first electrode, a second electrode, and a dielectric, for example. The capacitor may include one capacitor element, or two or more capacitor elements.

### First Electrode

The first electrode is an anode, for example. The first electrode includes an anode body, for example. The anode body may contain a valve metal, an alloy containing the valve metal, a compound containing the valve metal, or the like. The anode body may contain one kind of these materials, or two or more kinds thereof in combination. Examples of the valve metal include tantalum, aluminum, niobium, and titanium.

When the dielectric is formed by oxidation of the first electrode (i.e., when the dielectric is the oxide film of the first electrode), the first electrode contains tantalum. When the first electrode is formed by the gas phase method or the like, the first electrode does not necessarily contain tantalum. The first electrode containing tantalum may be made of tantalum or a tantalum alloy, or may be made of tantalum.

The anode body includes a porous part at least in a surface layer. This kind of porous part allows the anode body to have a fine uneven shape at least on a surface of the anode body. The anode body with the surface layer provided with the porous part is obtained by roughening a surface of a base material (e.g., a base material in a sheet shape, such as a foil shape or a plate shape, etc.) containing the valve metal, for example. The roughening may be performed by etching treatment, for example. The anode body may be a molded body of particles containing the valve metal or a sintered body thereof. Each of the molded body and the sintered body may entirely constitute the porous part. This kind of porous part and sintered body may be simply referred to as a porous body. Each of the molded body and the sintered body may have a sheet shape, a rectangular parallelepiped, a cube, or a shape similar thereto.

The anode body may be divided into a cathode formation part facing the second electrode (specifically, the cathode) and an anode lead-out part not facing the second electrode. The anode body may include a porous body and a wire inserted into the porous body. In this case, the wire corresponds to the anode lead-out part. The anode lead-out part is used for electrical connection to an external electrode or a lead terminal on an anode side, for example.

### Dielectric

The dielectric is formed covering at least a part of the surface of the anode body, for example. The dielectric layer is an insulating layer that functions as a dielectric.

When the dielectric is the oxide film of the first electrode, the first element is unevenly distributed in the surface layer of the dielectric on the side opposite to the first electrode (i.e., the side close to the second electrode). The dielectric is formed on a porous surface of the first electrode, so that the surface of the dielectric has a fine uneven shape corresponding to unevenness of the first electrode.

In the present disclosure, the dielectric described above achieves high withstand voltage and reduces a leak current. For example, as compared with an anode body having a dielectric formed by general chemical conversion treatment using a phosphoric acid aqueous solution, the anode body including the dielectric of the present disclosure can reduce a leak current by about 20% when an electric field intensity of 5.8 MV/cm is applied. These anode bodies each have similar capacitance per unit area (about 1.3×10⁻⁷ F/cm²).

### Electrolyte

The electrolyte contained in the capacitor may be a liquid electrolyte, a solid electrolyte, or both of them. The solid electrolyte and a liquid component may be used in combination. The solid electrolyte may constitute the second electrode together with a cathode lead-out layer.

The liquid electrolyte contains a solvent and a solute. The solvent is preferably a nonaqueous solvent. Examples of the nonaqueous solvent include a sulfone compound (sulfolane, dimethyl sulfoxide, ethyl sulfoxide, etc.), a lactone compound (γ-butyrolactone, γ-valerolactone, etc.), a carbonate compound (ethylene carbonate, propylene carbonate, fluoroethylene carbonate, ethyl methyl carbonate, etc.), a carboxylic acid ester compound, and an alcohol compound (ethylene glycol, polyethylene glycol, etc.). The liquid component may contain one kind of solvent (nonaqueous solvent or the like) or may contain two or more kinds of solvent in combination.

Examples of the solute include an acid component and a base component. As the solute, a salt of the acid component with the base component may be used. The acid component is preferably an aromatic carboxylic acid (benzoic acid, salicylic acid, etc.), an aromatic polycarboxylic acid (phthalic acid, etc.), or the like. Examples of the base component include organic bases (amines, quaternary ammonium compounds, etc.) and inorganic bases (metal hydroxides, etc.).

The liquid electrolyte is housed in the exterior body such as a case together with a capacitor element, for example.

As the solid electrolyte, a gel electrolyte or a polymer electrolyte obtained by solidifying a liquid electrolyte with a gelling agent or a polymer may be used. As the solid electrolyte, a conductive polymer may be also used. The conductive polymer may be a conductive polymer containing a conjugated polymer and a dopant, or a self-doped conductive polymer, or both of them may be used.

Examples of the conjugated polymer include a π-conjugated polymer. Examples of the conjugated polymer include a polymer having polypyrrole, polythiophene, polyaniline, polyfuran, polyacetylene, polyphenylene, polyphenylene vinylene, polyacene, or polythiophene vinylene as a basic skeleton. This kind of polymer is required to contain at least one kind of monomer unit constituting the basic skeleton. The monomer unit also includes a monomer unit having a substituent. Examples of the polymer include a homopolymer and a copolymer of two or more kinds of monomer. Examples of polythiophene include poly (3,4-ethylenedioxythiophene) (PEDOT). The solid electrolyte may contain one kind of conjugated polymer, or may contain two or more kinds thereof in combination.

Examples of the dopant include at least one kind selected from a group consisting of an anion and a polyanion. Examples of the anion include a sulfate ion, a nitrate ion, a phosphate ion, a borate ion, an organic sulfonate ion, and a carboxylate ion. As the dopant, a compound capable of generating an anion may be used. Examples of this kind of compound include p-toluenesulfonic acid and naphthalenesulfonic acid. Examples of the polymer anion include polyvinylsulfonic acid, polystyrenesulfonic acid (PSS), polyallylsulfonic acid, polyacrylsulfonic acid, polymethacrylsulfonic acid, poly (2-acrylamide-2-methylpropanesulfonic acid), polyisoprenesulfonic acid, polyestersulfonic acid (aromatic polyestersulfonic acid and the like), phenolsulfonic acid novolac resin, and polyacrylic acid. These are merely examples, and the dopant is not limited thereto. The solid electrolyte may contain one kind of dopant or two or more kinds of dopant in combination.

Examples of the liquid component used in combination with the solid electrolyte include the nonaqueous solvent described above. A protic solvent such as an alcohol compound may be used. One kind of nonaqueous solvent may be used singly, or two or more kinds thereof may be used in combination.

The solid electrolyte containing a conductive polymer may be formed by polymerizing a precursor (such as a monomer) of a conjugated polymer on a dielectric in the presence of a dopant, for example. For the polymerization, chemical polymerization, electrolytic polymerization, or the like is used. The solid electrolyte may be formed by applying a solution in which the conductive polymer is dissolved or a liquid dispersion in which the conductive polymer is dispersed to a surface of the dielectric. The solid electrolyte may form a layer in a capacitor element. The solid electrolyte layer may be a single layer or multiple layers.

The gel electrolyte is housed in the exterior body such as a case together with the capacitor element. The capacitor element may be formed by interposing a polymer electrolyte between the first electrode and the second electrode.

### Second Electrode

The second electrode is a cathode, for example. The second electrode includes an electrode lead-out layer (referred to also as a cathode lead-out layer). The solid electrolyte and the electrode lead-out layer may constitute the second electrode.

The electrode lead-out layer includes at least a metal-containing layer. Examples of the metal-containing layer include metal foil and a metal particle-containing layer.

The type of metal constituting the metal foil is not particularly limited. As the metal foil, a valve metal (tantalum, aluminum, niobium, etc.) or an alloy containing the valve metal may be used. The surface of the metal foil may be roughened as necessary.

The surface of the metal foil may be provided with a chemical conversion film, and may be provided with a film of metal (dissimilar metal) different from the metal constituting the metal foil, or a nonmetal film. Examples of the dissimilar metal and the nonmetal include metal such as titanium and nonmetal such as conductive carbon, respectively. The metal foil is layered on a base layer (the dielectric, the solid electrolyte, a carbon layer described later, etc.).

Examples of the metal material constituting the metal particles contained in the metal particle-containing layer include silver, a silver alloy, copper, and a copper alloy.

The metal particle-containing layer is formed by applying a metal paste containing metal particles and a resin binder to the base layer (the dielectric, the solid electrolyte, the carbon layer described later, etc.), and drying or solidifying a coating film. As the resin binder, a thermoplastic resin may be used, or a thermosetting resin such as an imide resin or an epoxy resin may be used. The metal particle-containing layer having been obtained may contain the metal particles, and the resin binder or a cured product of the resin binder.

The electrode lead-out layer may include the carbon layer and the metal-containing layer covering the carbon layer. For example, when the second electrode includes a solid electrolyte, the second electrode may further include the carbon layer covering at least a part of the solid electrolyte and the metal-containing layer covering at least a part of the carbon layer. The carbon layer contains conductive carbon, for example, and may contain a resin binder (water-soluble resin, curable resin, etc.) or a cured product of the resin binder as necessary. Examples of the conductive carbon include graphite (artificial graphite, natural graphite, and the like).

The carbon layer is formed by applying the conductive carbon, and a conductive paste or a liquid dispersion containing a resin binder as necessary, to the surface of the base layer (the dielectric, the solid electrolyte, etc.) and drying or solidifying the conductive paste or the liquid dispersion, for example.

In the process of forming the electrode lead-out layer, heat treatment or the like may be performed as necessary.

These configurations are merely examples of the configuration of the electrode lead-out layer, and may be other configurations having a current collecting function.

### Others

The capacitor may be a wound type, or may be a chip type or a layered type. When the capacitor includes a plurality of capacitor elements, each of the capacitor elements may be a wound type or a layered type, for example. For example, the layered capacitor includes a plurality of capacitor elements layered. The capacitor element may be selectively configured according to a type of the capacitor.

The electrode lead-out layer of the second electrode is electrically connected to one end part of a second lead terminal in the capacitor element, for example. For example, an electrode lead-out part (e.g., the anode extraction part) of the first electrode is electrically connected to one end part of a first lead terminal. The other end part of each lead terminal is drawn out from the exterior body. The other end part of each lead terminal exposed from the exterior body is used for solder connection to a substrate on which the capacitor is to be mounted, and is electrically connected to the external electrode. At least a part of the external electrode constitutes an external terminal of the capacitor. As each lead terminal, a lead wire may be used, or a lead frame may be used. Other than when the lead terminal is used, an end surface of the electrode lead-out part (e.g., the anode lead-out part) may be exposed from the exterior body and connected to the external electrode. An end surface of the metal foil included in the second electrode may be exposed from the exterior body and connected to the external electrode. An end surface of the other end part of the second lead terminal connected to the electrode lead-out layer of the second electrode may be exposed from the exterior body and connected to the external electrode.

The capacitor element is sealed by the exterior body, for example. For example, the capacitor element and a material resin (e.g., uncured thermosetting resin and filler) of the exterior body may be housed in a mold to seal the capacitor element with the resin exterior body by a transfer molding method, a compression molding method, or the like. At this time, a part close to the other end part of each lead terminal drawn out from the capacitor element is exposed from the mold. Alternatively, the capacitor element may be housed in a bottomed case while a part close to the other end of each lead terminal is located close to an opening of the bottomed case, and the opening of the bottomed case may be sealed with a sealing body to form the capacitor.

### Device Including Capacitor

The capacitor of the present disclosure has high capacitance and high withstand voltage, and thus has high reliability. Thus, the capacitor is used for various applications (devices) requiring high capacitance, high withstand voltage, high reliability, and the like. The device equipped with the capacitor is not particularly limited, and examples thereof include various electronic devices, various electric devices, and in-vehicle applications.

FIG. 1 is a sectional view schematically illustrating a capacitor element including a dielectric according to an exemplary embodiment of the present disclosure.

Capacitor element 10 includes first electrode 11 and second electrode 13. First electrode 11 includes porous body 111 made of tantalum, electrode wire 112 made of porous body 111, and dielectric 113 covering at least a part of porous body 111. Second electrode 13 includes solid electrolyte layer 131, carbon layer 132, and metal particle-containing layer 133. Carbon layer 132 and metal particle-containing layer 133 each function as a cathode lead-out layer. This kind of capacitor element 10 has a substantially cubic shape. In the present disclosure, dielectric 113 contains a tantalum compound containing oxygen and a first element. When dielectric 113 contains the first element (preferably, is unevenly distributed in a surface layer of dielectric 113), a defect level of oxygen is stabilized by charge compensation of the first element, and thus high capacitance and high withstand voltage can be secured.

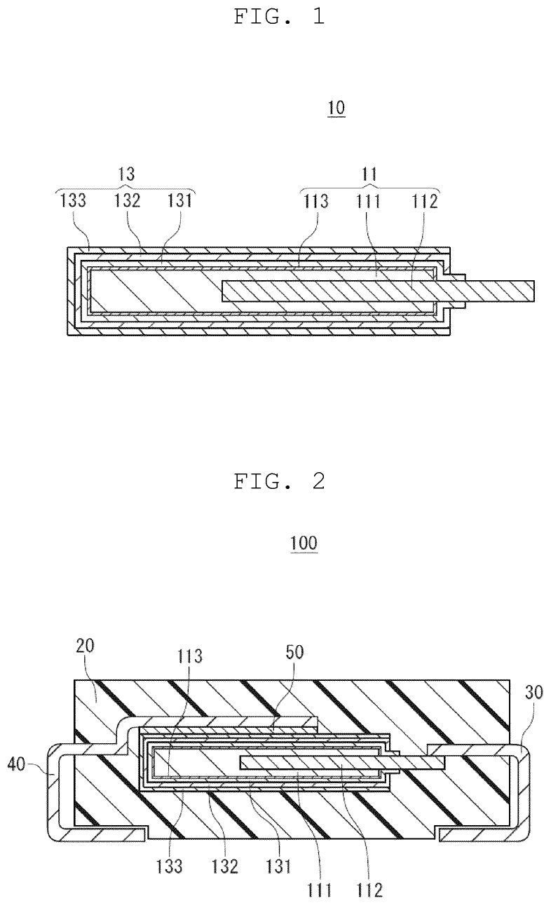

FIG. 2 is a sectional view schematically illustrating a capacitor according to an exemplary embodiment of the present disclosure.

Capacitor 100 includes the capacitor element of FIG. 1, exterior body 20 that seals the capacitor element, and first lead terminal 30 and second lead terminal 40 that are at least partially exposed to the outside of exterior body 20.

Electrode wire 112 and first lead terminal 30 are electrically connected by welding, for example. Metal particle-containing layer 133 and second lead terminal 40 are electrically connected with adhesive layer 50 that is made of a conductive adhesive (e.g., a mixture of thermosetting resin and carbon particles or metal particles), for example, and that is interposed between metal particle-containing layer 133 and second lead terminal 40.

Although the example of FIG. 2 shows a capacitor in which a solid electrolyte is used as an electrolyte and a capacitor element is sealed by an exterior body, the capacitor of the present disclosure is not limited to only such a combination. For example, the capacitor of the present disclosure may include a capacitor element and a liquid electrolyte that are housed in a case.

### Examples

Although the present disclosure is specifically described below with reference to Examples and Comparative Examples, the present disclosure is not limited to the Examples below.

### Example 1

Samples for evaluation were prepared in the following manner, and characteristics of the samples were evaluated.

### (i) Preparation of First Electrode

Commercially available tantalum foil was cut into a shape of 10 mm square to 50 mm square to obtain a precursor of a first electrode as a tantalum anode body in the shape of a flat plate.

### (ii) Formation of Oxide Film (Dielectric)

As a chemical conversion solution, an aqueous solution containing K₂SiO₃ at a concentration of 0.001 mass % to 10.00 mass % was prepared. A chemical conversion tank was filled with the chemical conversion solution, and a part of the tantalum anode body in the shape of a flat plate was immersed in the chemical conversion solution. The chemical conversion solution had a temperature of 50° C. to 100° C. The tantalum anode body in the shape of a flat plate had an upper end that was not immersed in the liquid and was connected to a counter electrode, and voltage was raised at a rate of 30 V/h to 50 V/h until conversion voltage reached a voltage of 50 V to 100 V, and then the tantalum anode body was maintained at a predetermined voltage for 5 hours to 15 hours. At this time, the maximum current density was within a range of 0.10 mA/cm² to 10.00 mA/cm² and the minimum current density was within a range of 0.001 mA/cm² to 0.100 mA/cm² throughout a chemical conversion step. In this way, an oxide film (with a thickness of about 100 nm to 180 nm) of tantalum oxide containing silicon as the first element was formed on a part of the surface of the tantalum anode body in the shape of a flat plate. Ten samples in total for evaluation of the first electrode provided with the oxide film were prepared.

### (iii) Formation of Upper Electrode

On a surface of the oxide film of the first electrode obtained in step (ii) above, 100 to 200 upper electrodes each in a dot shape with a diameter of 0.1 mm to 1 mm were formed at equal intervals using a predetermined metal mask and a large electron beam vapor deposition machine. In this way, four samples in total for leak current evaluation were prepared.

### Comparative Example 1

In place of the aqueous solution containing K₂SiO₃ in step (ii) of Example 1, an aqueous solution containing phosphoric acid at a concentration of 0.001 mass % to 1.000 mass % and hydrogen peroxide at a concentration of 0.001 mass % to 10.000 mass % was used as a chemical conversion solution. Except for this, the first electrode was prepared as in Example 1, and ten samples in total for evaluation of the first electrode provided with the oxide films and four samples in total for leak current evaluation were prepared.

### Evaluation

### (1) Analysis of Oxide Film (Dielectric)

The evaluation samples of the first electrode obtained in step (ii) above were subjected to the following analysis to calculate an average value.

### (1-1) XPS Analysis

Elemental analysis was performed in a thickness direction (depth direction) from the surface of the oxide film (dielectric) according to the procedure described above.

On the outermost surface of the oxide film of Example 1, a content of each element is as follows: 67 atom % O; 17 atom % Si; 7.8 atom % Ta; 2.8 atom % Al; and 1.1 atom % K; and P was not more than a detection limit. In a part (outermost layer) from the outermost surface to a thickness of 10 nm from the outermost surface of the oxide film of Example 1, a content of silicon was about 17 atom %. Ratio r1/r2 was about 100.

On the outermost surface of the oxide film of Comparative Example 1, a content of each element is as follows: 64 atom % O; 18 atom % Ta; and 2.7 atom % P; and Si, Al, and K were each not more than a detection limit.

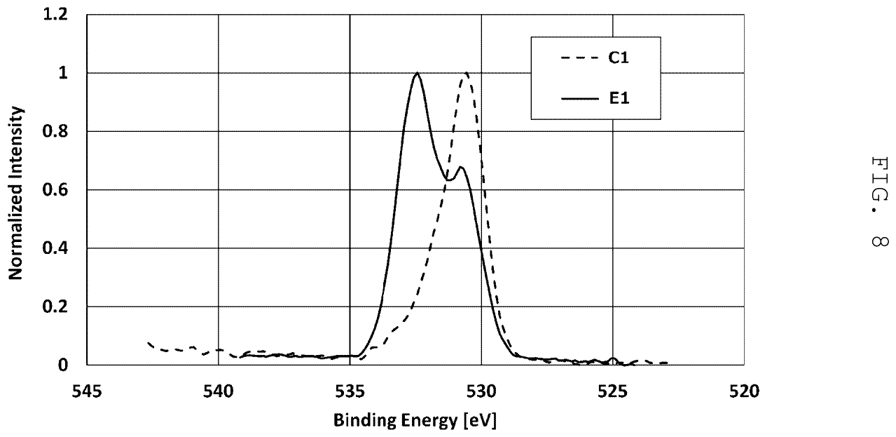

FIGS. 7 and 8 each show elemental analysis spectra of the outermost surface of the oxide film (dielectric) of each of Example 1 and Comparative Example 1 by the XPS. FIGS. 7 and 8 each show Example 1 designated by E1 and Comparative Example 1 designated by C1. As shown in FIG. 7, the XPS spectrum of the outermost surface of the oxide film in Example 1 shows a peak attributed to Si2p, the peak being observed at bond energy around 103 eV. In contrast, this kind of peak was not observed in Comparative Example 1. As shown in FIG. 8, the XPS spectrum of the outermost surface of the oxide film in Example 1 shows a peak attributed to O₁ₛ derived from a Si—O bond, the peak being observed at bond energy around 533 eV. In contrast, this kind of peak was not observed in Comparative Example 1, and an O₁ₛ peak derived from a Ta—O bond was observed at high intensity around bond energy of 531 eV. Although an O₁ₛ peak derived from the Ta—O bond was observed around the bond energy of 531 eV even in Example 1, intensity of the peak was lower than that of any of the O₁ₛ peak derived from the Si—O bond and the O₁ₛ peak derived from the Ta—O bond in Comparative Example 1.

### (1-2) TOF-SIMS Analysis

TOF-SIMS analysis was performed for the outermost surface of the oxide film and the inside of the oxide film. The analysis of the oxide film was performed under conditions below after minute surface deposits were removed with a gas cluster ion beam (GCIB).

Apparatus: TRIFTV nano TOF (manufactured by ULVACI, Inc.)
Primary ion condition: 30Au₃200 bunching mode
Use of neutralization gun
Primary ion species: Au3+ (=Au trimer)
Acceleration voltage: 30 kV
Bunching mode (irradiation with a primary ion beam in a pulsed manner)
Primary ion irradiation area (=measurement area):
100 μm×100 μm (for measurement of outermost surface); and
50 μm×50 μm (for analysis in depth direction)
Sputtering conditions:
   Sputtering Ion Species: Au3+
   Continuous beam
   Raster range: 150 μm×150 μm

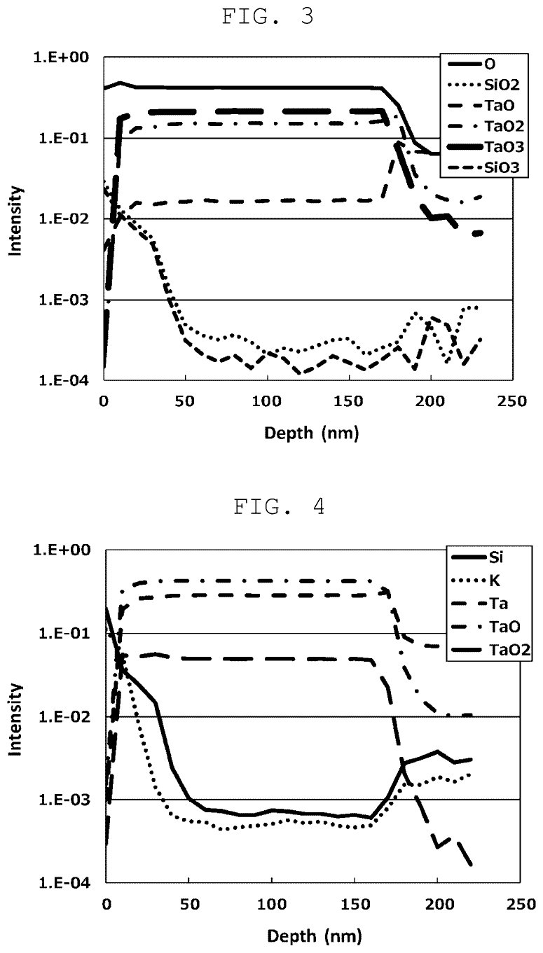

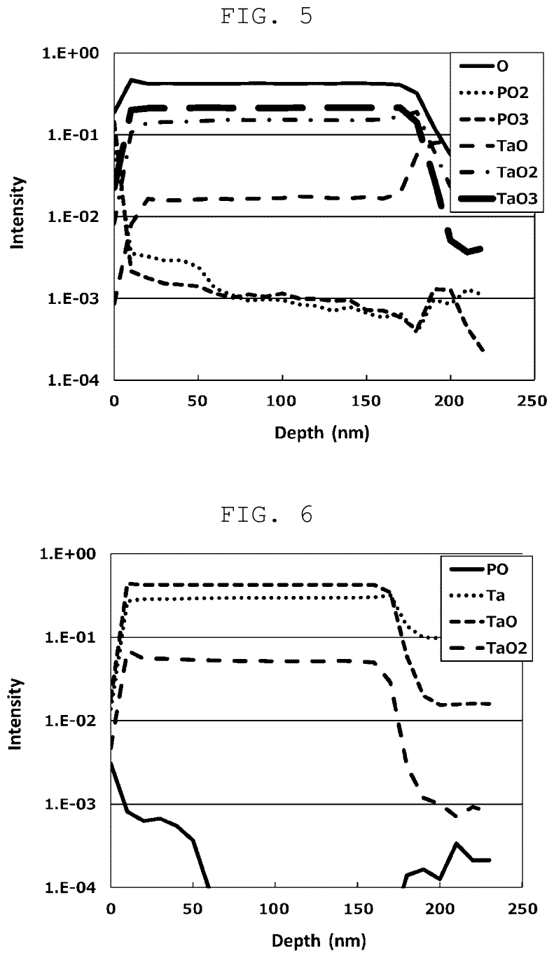

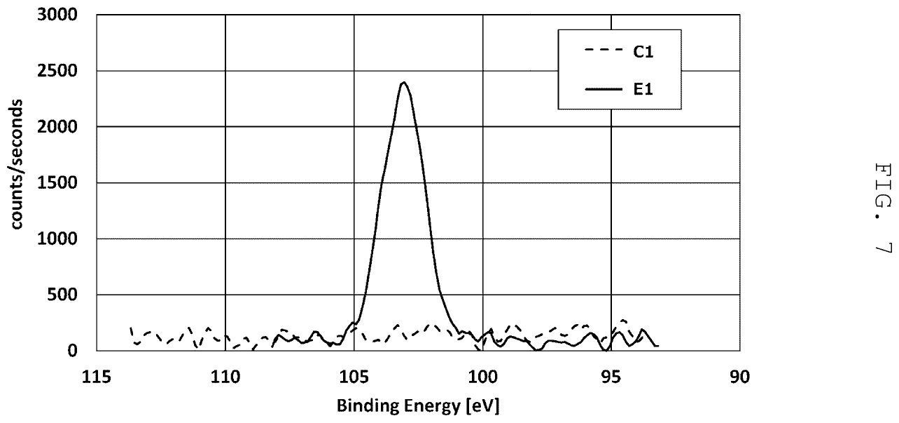

Analysis results of Example 1 by the TOF-SIMS using the negative mode and the positive mode are shown in FIGS. 3 and 4, respectively. Analysis results of Comparative Example 1 by the TOF-SIMS using the negative mode and the positive mode are shown in FIGS. 5 and 6, respectively. The oxide film of Example 1 contained many chemical species containing Si in a part from the outermost surface to a depth (thickness) of about 50 nm from the outermost surface (a part from the outermost surface to a thickness of about 0.3 T with respect to average thickness T of a dielectric layer, the part corresponding to a surface layer). A part other than the surface layer had a very small content of the chemical species containing Si. As described above, the first element was unevenly distributed in the surface layer in Example 1. The chemical species containing Si had particularly high contents of SiO₂ and SiO₃. The oxide film of Example 1 showed that chemical species containing phosphorus was not more than a detection limit both on a surface of the oxide film and inside the oxide film. The oxide film of Comparative Example 1 contained a large amount of the chemical species containing phosphorus in a part of about 10 nm deep from the outermost layer, and a part deeper than 10 nm from the outermost layer had a very small content of the chemical species containing phosphorus.

### (2) Leak Current

A leak current value of the first electrode was measured using the evaluation samples obtained in step (iii).

For the measurement, a manual prober generally used for evaluating electrical characteristics of a thin film material and a semiconductor parameter analyzer connected thereto were used. The probe on a plus side was applied to a part without chemical conversion of the first electrode as a lower electrode, and the probe on a minus side was applied to the upper electrode formed in step (iii). When the probe on the negative side was fixed at 0 V and the probe on the positive side was swept from 0 V to 100 V, a value of a current flowing between the electrodes was measured, and a relationship between electric field intensity and the value of the current flowing through the first electrode was examined. As a result, a current value at an electric field intensity of 5.8 MV/cm in Example 1 was reduced by about 20% from a current value in Comparative Example 1. As described above, Example 1 showed that a leak current when voltage was applied was reduced as compared with Comparative Example 1, and high withstand voltage was exhibited.

### (3) Capacitance

For the evaluation samples obtained in step (iii), initial electrostatic capacitance (F/cm²) per unit area of the upper electrode on the surface of the anode body was measured using an impedance analyzer connected to a prober under room temperature environment. The measurement was performed while frequency was changed from 1 kHz to 100 kHz. For each frequency, an average value of 20 capacitors was obtained. As a result, the capacitance hardly changed at any frequency, and high capacitance was obtained in Example 1 and Comparative Example 1.

### INDUSTRIAL APPLICABILITY

Using the dielectric of the present disclosure enables a capacitor to secure high capacitance and high withstand voltage. Thus, a highly reliable capacitor having high withstand voltage while having high capacitance can be obtained. This kind of capacitor is suitable for applications requiring high capacitance and applications requiring high reliability. However, the applications of the dielectric and the capacitor are not limited to these.

### REFERENCE MARKS IN THE DRAWINGS

100 capacitor
10 capacitor element
11 first electrode
111 porous body
112 electrode wire
113 dielectric
13 second electrode
131 solid electrolyte layer
132 carbon layer
133 metal particle-containing layer
20 exterior body
30 first lead terminal
40 second lead terminal
50 adhesive layer

1. A dielectric comprising a tantalum compound, wherein:
the tantalum compound contains:
oxygen; and
a first element other than oxygen and tantalum, and
the first element is an element having a valence electron number of four or less and is capable of being a positive ion in an ionic state.

2. The dielectric according to claim 1, wherein the first element is unevenly distributed in a surface layer of the dielectric.

3. The dielectric according to claim 2, wherein a content of the first element ranges from 10 atom % to 30 atom %, inclusive, in a portion from an outermost surface of the surface layer of the dielectric to a position away from the outermost surface by a thickness of 10 nm.

4. The dielectric according to claim 2, wherein a content of the first element ranges from 10 atom % to 30 atom %, inclusive, at an outermost surface of the surface layer.

5. The dielectric according to claim 2, wherein, in a spectrum obtained by an X-ray photoelectron spectroscopy at an outermost surface of the surface layer, a peak attributed to O₁ₛ derived from a bond between the first element and oxygen is observed in the spectrum.

6. The dielectric according to claim 1, wherein the first element includes an element in which a dielectric constant of an oxide is lower than a dielectric constant of an oxide of tantalum.

7. The dielectric according to claim 1, wherein the first element includes at least one selected from the group consisting of Group 4 elements and Group 14 elements of a periodic table.

8. The dielectric according to claim 1, wherein the first element contains at least a silicon element.

9. The dielectric according to claim 8, wherein, in a spectrum obtained by an X-ray photoelectron spectroscopy at an outermost surface of the surface layer, a peak attributed to Si₂ₚ is observed in the spectrum.

10. The dielectric according to claim 2, wherein a withstand voltage of the surface layer is higher than a withstand voltage of a part other than the surface layer of the dielectric.

11. A capacitor comprising:
a first electrode;
a second electrode; and
the dielectric according to claim 1, the dielectric being disposed between the first electrode and the second electrode.

12. The capacitor according to claim 11, wherein:
the first electrode contains tantalum,
the dielectric is an oxide film of the first electrode, and
the first element is unevenly distributed in a surface layer of the dielectric, the surface layer being located close to the second electrode.

13. The capacitor according to claim 11, further comprising an electrolyte.

14. A device comprising the capacitor according to claim 11.
